(19) United States
(12) Patent Application Publication
(10) Pub. No.: US 2016/0054202 A1
(43) Pub. Date: Feb. 25, 2016

(54) DIURNAL URINE COLLECTION SYSTEM

(71) Applicant: INFINITE MEDICAL TECHNOLOGY CORP., Carson, CA (US)

(72) Inventor: Peter A.K. YONG, Carson, CA (US)

(21) Appl. No.: 14/846,248

(22) Filed: Sep. 4, 2015

Related U.S. Application Data
(63) Continuation-in-part of application No. 14/020,827, filed on Sep. 7, 2013.
Application No. 14/020,827 is a continuation of application No. 12/947,786, filed on Nov. 16, 2010, now abandoned.
Application No. 12/947,786 is a continuation-in-part of application No. 11/505,770, filed on Aug. 16, 2006, now abandoned.
Application No. 11/505,770 is a continuation-in-part of application No. 11/191,300, filed on Jul. 28, 2005, now abandoned.
(60) Provisional application No. 62/046,091, filed on Sep. 4, 2014.
(60) Provisional application No. 61/261,512, filed on Nov. 16, 2009.
(60) Provisional application No. 60/598,812, filed on Aug. 4, 2004.

(51) Int. Cl. G01N 1/12

(52) U.S. Cl. CPC G01N 1/12

(57) ABSTRACT

Collection systems for a liquid sample are described. In one embodiment, a collection system includes a first collection container, a second collection container, a funnel, and a diverter valve. The diverter valve is coupled to the first collection container, the second collection container, and the funnel. The diverter valve may have a first position configured to direct the liquid sample from the funnel into the first collection container, and a second position configured to direct the liquid sample from the funnel into the second collection container.

### CROSS-REFERENCE TO RELATED APPLICATIONS

This application claims the benefit of U.S. provisional application No. 62/046,091, filed Sep. 4, 2014. This application is a continuation-in-part of U.S. patent application Ser. No. 14/020,827, filed Sep. 7, 2013, which is a continuation of U.S. patent application Ser. No. 12/947,786, filed Nov. 16, 2010, now abandoned, which claims the benefit of U.S. provisional application No. 61/261,512, filed Nov. 16, 2009, and is a continuation-in-part of U.S. patent application Ser. No. 11/505,770, filed Aug. 16, 2006, now abandoned, which is a continuation-in-part of U.S. patent application Ser. No. 11/191,300, filed Jul. 28, 2005, now abandoned, which claims the benefit of U.S. provisional application No. 60/598,812, filed Aug. 4, 2004. The applications listed above are hereby incorporated by reference in their entireties.

### BACKGROUND

Collection containers are given to patients to collect urine, blood, and other liquid samples.

One type of collection container includes a cup and a lid. The lid has a sampling opening or a simple hole with a hinged cover that provides access to the contents of the cup without having to remove the lid. This opening may allow the sample to accidentally splash out or otherwise escape from the opening when its cover is not securely fastened. To obtain some of the sample, a tube or other elongate instrument is extended through the opening directly into the liquid sample contents. Obtaining the sample in this manner may result in drips, or otherwise create exposure to a potentially hazardous sample.

Another type of collection container uses a tube holder with an exposed needle. This tube holder makes it more difficult for the sample to splash out. However, this tube holder creates the risk of the patient or other user accidentally pricking themselves with the needle, even if the needle is recessed in the tube holder. To obtain a portion of the sample, a vacuum sample collection tube is inserted in the tube holder and used with the needle. Obtaining the sample with this port requires a vacuum sample collection tube that has a limited shelf life and loses its vacuum with time.

Patients may in an unaware fashion set down the lid and aspiration tube on an unclean surface after they have removed the lid from the cup and before they fill the cup. When the lid is put back onto the cup, the exposed aspiration tube will contaminate the sample contents collected.

One type of collection container system is used to collect liquid samples from a patient over an extended period of time. This collection container system may simply include one or more collection containers with lids which are opened and closed to deposit the liquid samples. This creates the possibility of spilling each time the lid is opened. In addition, this type of collection container system is used to collect liquid samples from a patient for different time periods. This creates the possibility that the wrong collection container is used for a particular time period.

What is collection container system which can collect liquid samples from a patient without being opened.

What is also needed is a collection container system which can collect liquid samples from a patient for different time periods without being opened.

What is also needed is a collection container system which will reduce the chances that the wrong collection container is used for a particular time period.

### SUMMARY

Collection systems for a liquid sample are described. In one embodiment, a collection system includes a first collection container, a second collection container, a funnel, and a diverter valve. The diverter valve is coupled to the first collection container, the second collection container, and the funnel. The diverter valve may have a first position configured to direct the liquid sample from the funnel into the first collection container, and a second position configured to direct the liquid sample from the funnel into the second collection container.

### BRIEF DESCRIPTION OF THE DRAWINGS

FIGS. 1A-1C show one embodiment of a collection container 100.

FIGS. 2A-2H show one method of using collection container 100.

FIGS. 3A-3B show additional embodiments of collection container 200 and 300.

FIGS. 4A-4D show one embodiment of a urine collection system 1000.

FIGS. 5A-5G show another embodiment of a urine collection system 2000.

### DESCRIPTION

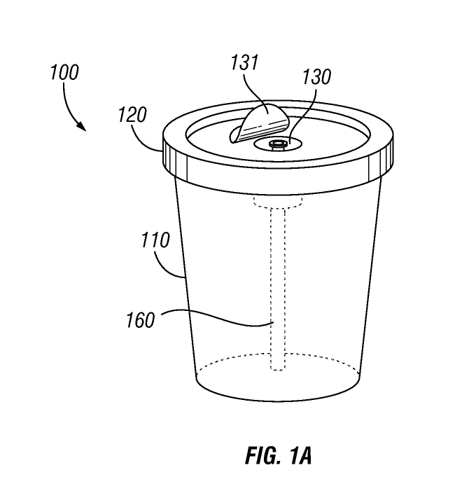

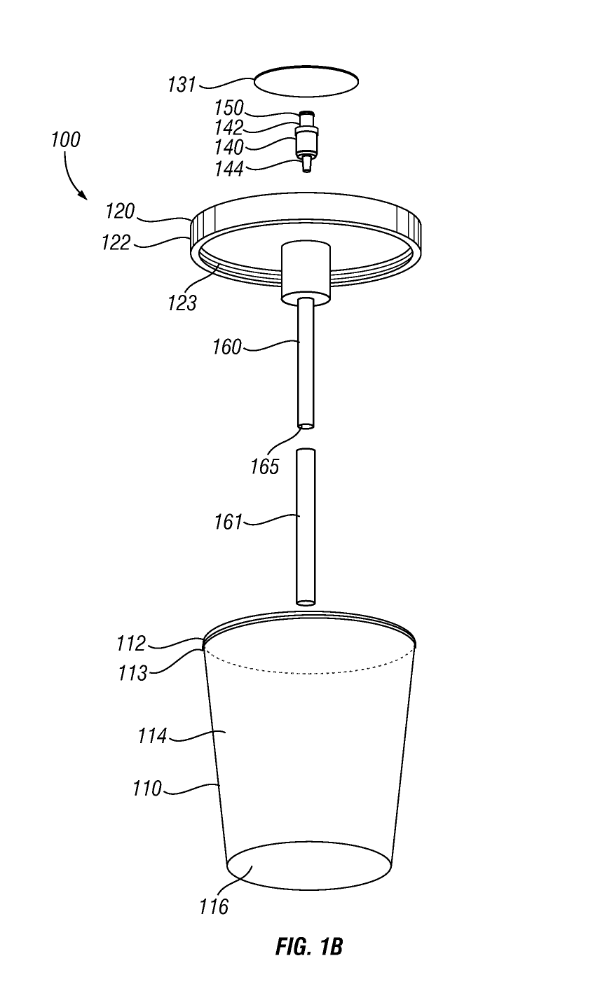

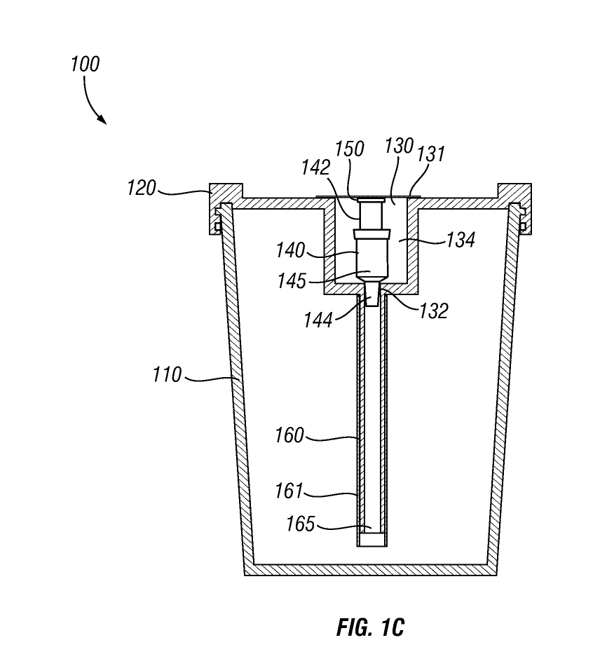

FIGS. 1A-1C show one embodiment of a collection container 100. FIG. 1A shows a perspective view of collection container 100. FIG. 1B shows an exploded view of collection container 100. FIG. 1C shows a cross-sectional view of collection container 100.

Collection container 100 includes a receptacle 110, a lid 120, a sampling port 130, a valve 140, a fitting 150, and an aspiration tube 160.

Receptacle 110 receives urine, blood, saliva, or other liquid samples. Receptacle 110 includes a mouth 112, sides 114, and a bottom 116. Mouth 112 may include threads 113 for coupling to lid 120. Sides 114 may be tapered, with mouth 112 being larger and bottom 116 being smaller. Bottom 116 may be configured to fit with a lid 120 of another receptacle 110 to allow multiple collection containers 100 to be stacked for storage or transportation. Receptacle 110 may be made of a plastic or other substantially rigid material. Receptacle 110 may be made of a material that is at least partially translucent. Receptacle 110 may be circular, oval, rectangular, or any other suitable shape.

Lid 120 seals mouth 112 of receptacle 110, and prevents the liquid sample from escaping between lid 120 and receptacle 110. Lid 120 is removably coupled to receptacle 110. Lid 120 may include a lip 122. Lip 122 may include threads 123 which are configured to couple to threads 113 of mouth 112. Alternatively, lid 120 may be coupled to receptacle with a press fit, a twist lock, or any other suitable method or device. Lip 122 may be raised and configured to receive a bottom 116 of another receptacle 110 to allow multiple collection containers 100 to be stacked for storage or transportation. Lip 122 may be knurled or textured to enhance grip.

Sampling port 130 allows access to the contents of receptacle 110 when lid 120 is coupled to receptacle 110. Sampling port 130 includes an opening 132 formed in lid 120. Sampling port 130 may also include a recess 134 formed in lid 120, with opening 132 located at a bottom of recess 134.

Sampling port 130 may be covered by a port seal 131 which keeps sampling port 130 clean until it is ready to be used. Port seal 131 may be made of paper, plastic, foil, or other suitable material. Port seal 131 may be affixed with an adhesive or other suitable method. Port seal 131 may have a pull tab, and is easily removed when sampling port 130 is ready to be used.

Valve 140 is coupled to opening 132 of sampling port 130. Valve 140 may be seated at a bottom of recess 134. Valve 140 has a top end 142, a bottom end 144, and a lumen 145. Top end 142 of valve 140 may be flush with a top of lid 120. Alternatively, top end 142 of valve 140 may be recessed with respect to the top of lid 120, or protrude above the top of lid 120.

Fitting 150 may be coupled to top end 142 of valve 140. Fitting 150 may be a luer attachment or other suitable fitting. Fitting 150 may be configured to be coupled to a sample collection device, such as any of the embodiments of a handle as described in U.S. Patent Application Publication No. 2007/0025886.

Valve 140 automatically closes to prevent the contents of receptacle 110 from leaking or escaping through sampling port 130 when lid 120 is in place. Valve 140 opens when a sample collection device is coupled to fitting 150. Valve 140 may be a uni-directional or bi-directional luer-activated checkvalve such as those available from Qosina Corporation, Edgewood, N.Y. or Baxter Healthcare Corporation, Round Lake, Ill.

Aspiration tube 160 is coupled to opening 132 of sampling port 130. Aspiration tube 160 includes a lumen 165 that is in fluid communication with lumen 145 of valve 140. When lid 120 is coupled to receptacle 110, aspiration tube 160 is of sufficient length to reach at least near bottom 116 of receptacle 110. Aspiration tube 160 allows most or all of the contents of receptacle 110 to be drawn out through aspiration tube 160.

Aspiration tube 160 may be covered by a sleeve 161 which keeps aspiration tube 160 clean or sterile until receptacle 110 is used. Sleeve 161 may be made of paper, plastic, or other suitable material. Sleeve 161 is configured to cover aspiration tube 160 and stay in place until removed. Sleeve 161 may be slightly longer than aspiration tube 160. Sleeve 161 may be open-ended or closed-ended.

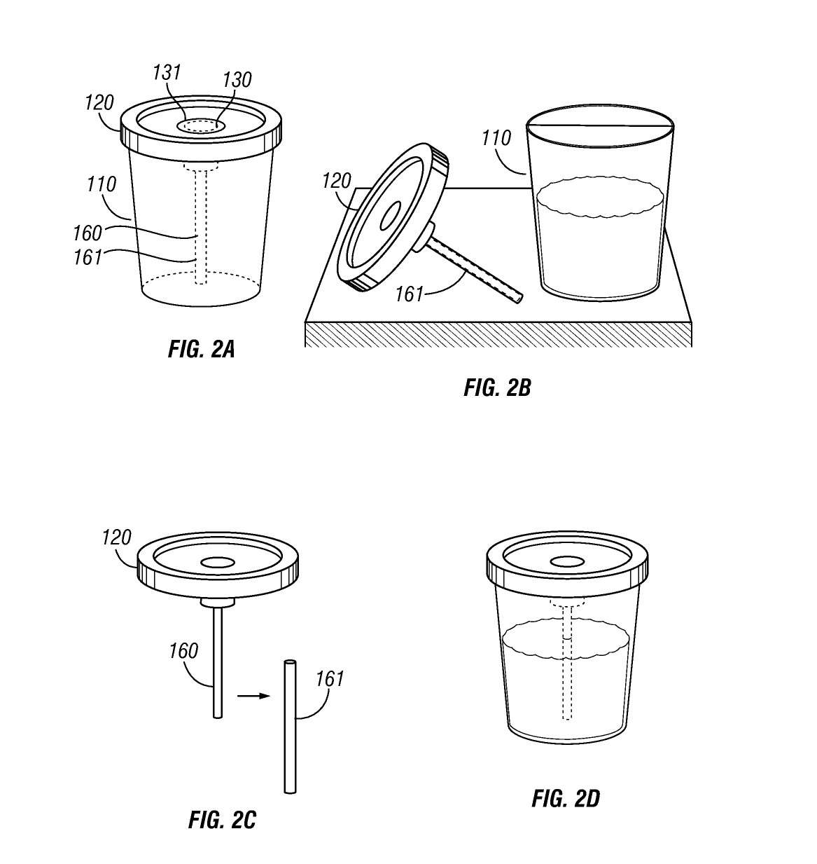

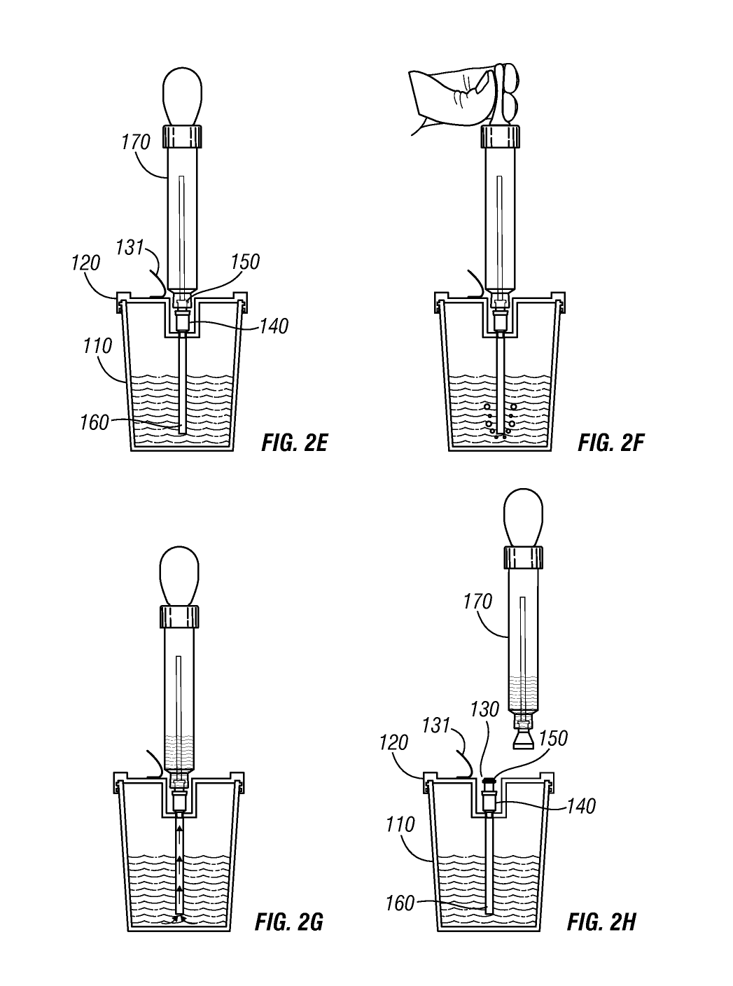

FIGS. 2A-2H show one method of using collection container 100.

FIG. 2A shows collection container 100 with receptacle 110 closed with lid 120. Collection container 100 is given to a patient.

FIG. 2B shows collection container 100 after the patient has removed lid 120 from receptacle 110. If the patient sets down lid 120, aspiration tube 160 is kept clean by sleeve 161. Receptacle 110 receives a sample from the patient.

FIG. 2C shows lid 120 held up and sleeve 161 removed from aspiration tube 160.

FIG. 2D shows lid 120 coupled back to receptacle 110, sealing the sample inside. The sample is prevented from leaking or escaping through sampling port 130 by valve 140.

FIG. 2E shows port seal 131 peeled back to expose sampling port 130, and a sample collection device 170 coupled to fitting 150 of valve 140. Valve 140 is opened when sample collection device 170 is coupled.

FIGS. 2F-2G shows sample collection device 170 being squeezed and released to create a vacuum that will draw the sample through aspiration tube 160 and valve 140 and into sample collection device 170. Sample collection device 170 may be squeezed one or more times to draw the desired amount of sample into sample collection device 170.

FIG. 2H shows sample collection device 170 disconnected from valve 140. Valve 140 is closed when sample collection device 170 is uncoupled. One or more additional sample collection devices 170 may be used to collect additional amounts of sample.

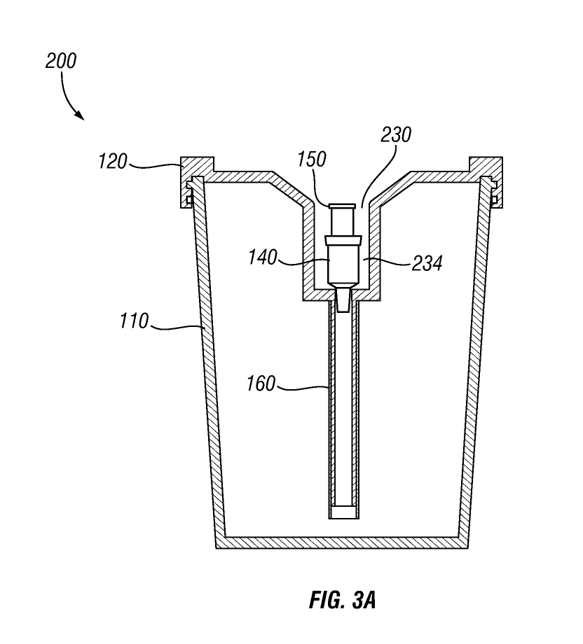

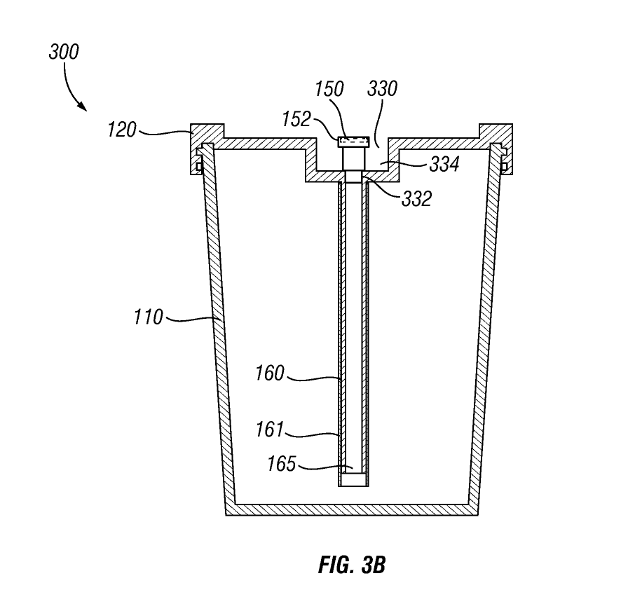

FIGS. 3A-3B show additional embodiments of collection container 200.

FIG. 3A shows another embodiment of collection container 200. Collection container 200 includes a receptacle 110, a lid 120, a sampling port 230, a valve 140, a fitting 150, and an aspiration tube 160. Collection container 200 is similar to collection container 100, but includes a sampling port 230 with a recess 234 that is shaped to guide a sample collection container to fitting 150 of valve 140.

FIG. 3B shows yet another embodiment of collection container 300. Collection container 300 includes a receptacle 110, a lid 120, a sampling port 330, a fitting 150, and an aspiration tube 160. Collection container 300 is similar to collection container 100, but does not include a valve. Fitting 150 is coupled to opening 332 in recess 334 of sampling port 330. Fitting 150 may be covered by a cap 152 which prevents the sample from escaping through sampling port 330.

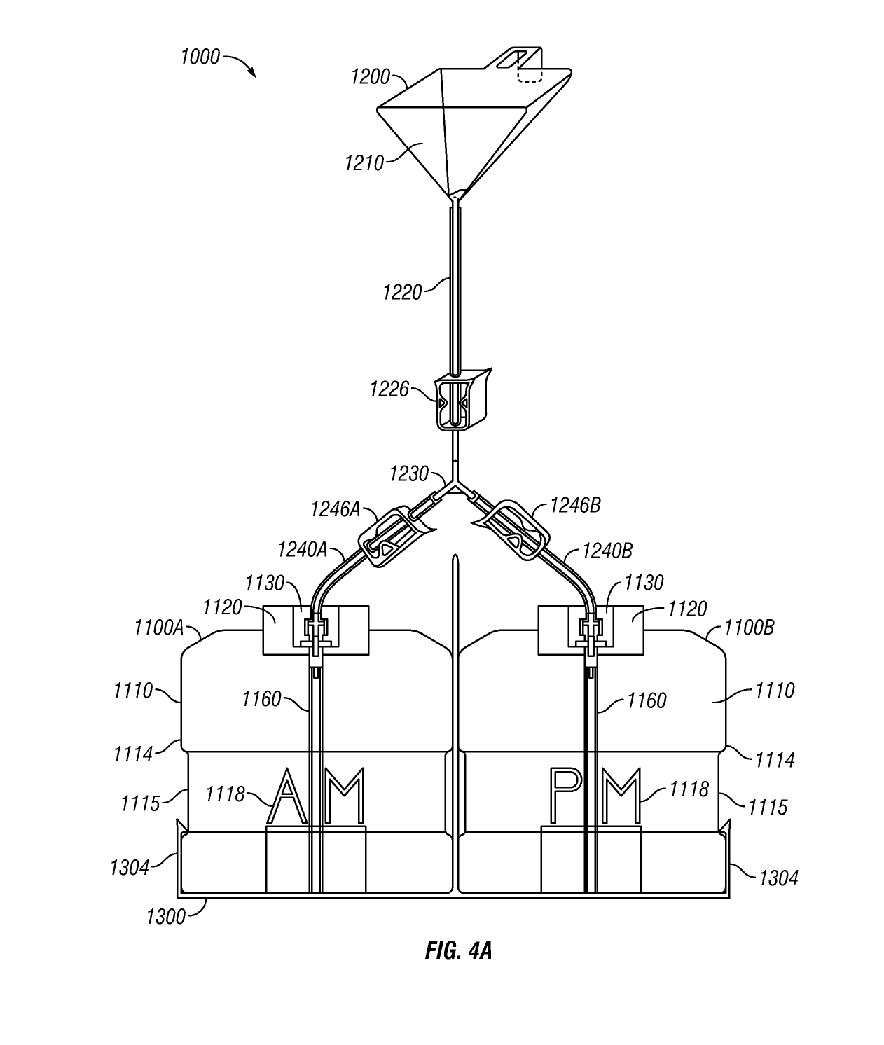

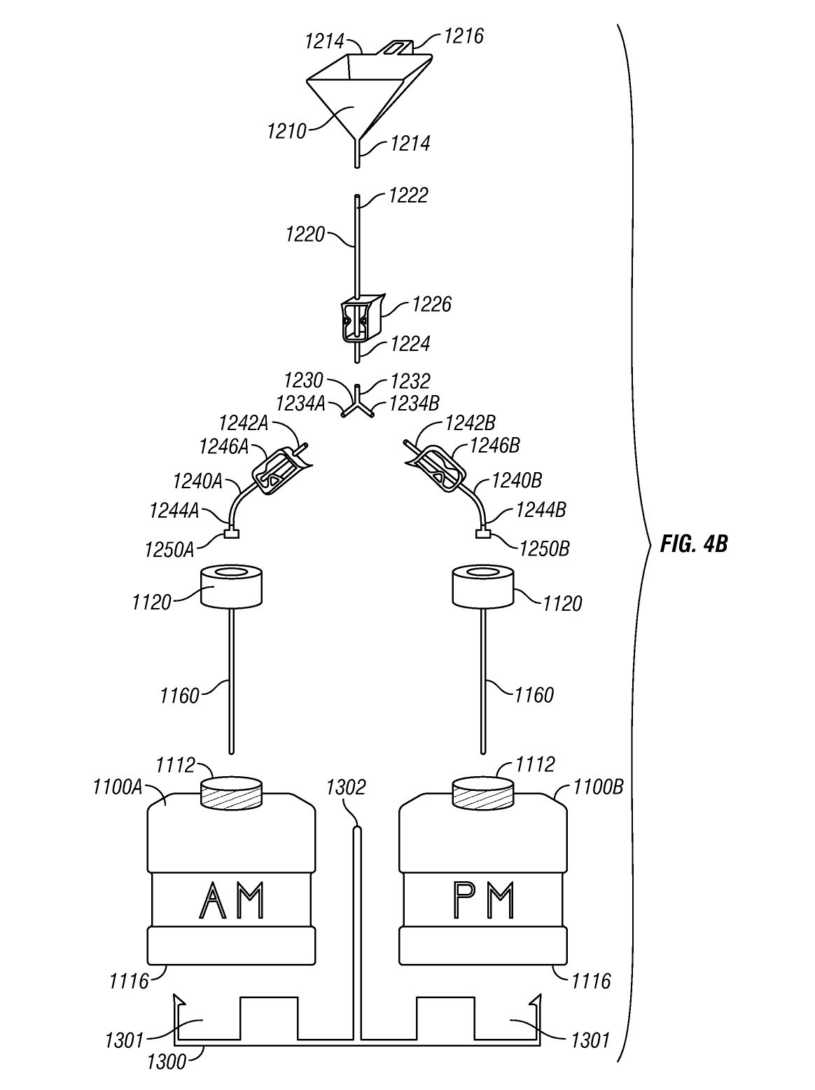

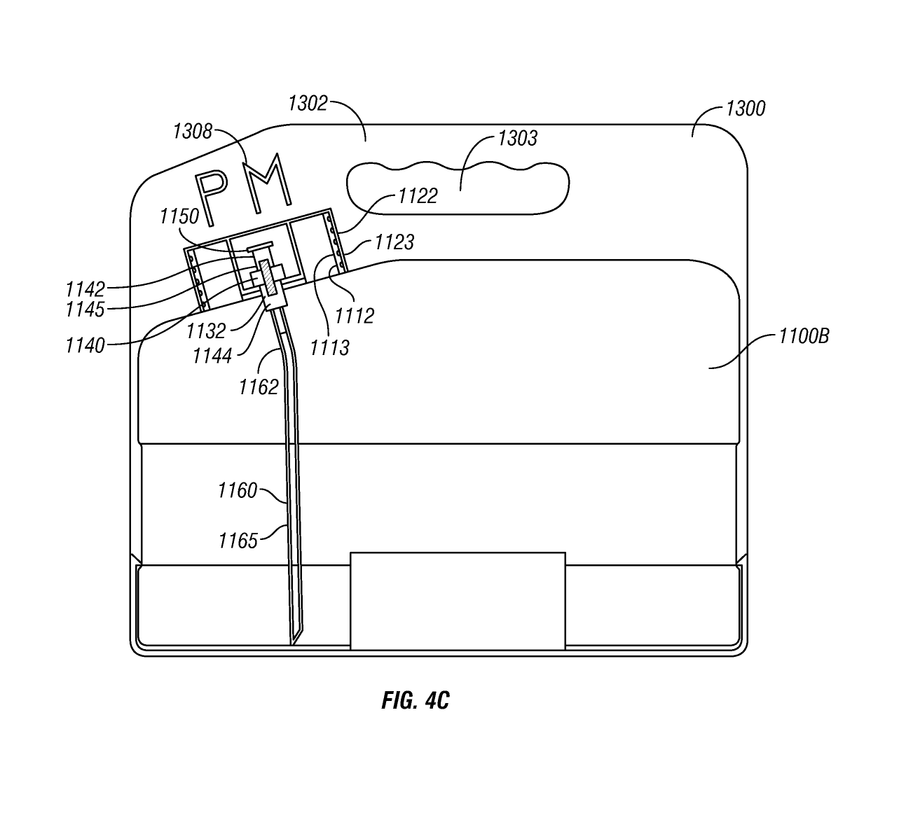

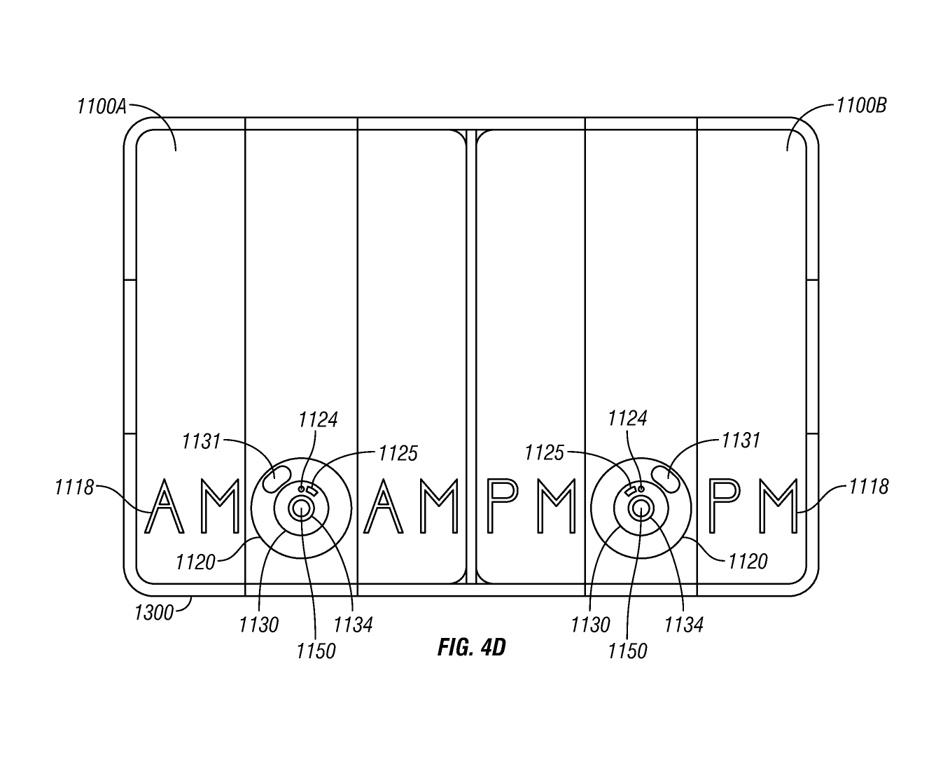

FIGS. 4A-4D show one embodiment of a urine collection system 1000. FIG. 4A shows a front view of urine collection system 1000, with a cross-sectional view of a lid 1120. FIG. 4B shows an exploded view of urine collection system 1000, with a cross-sectional view of lid 1120. FIG. 4C shows a side view of a second collection container 1100B and a carrier 1300, with a cross-sectional view of lid 1120. FIG. 4D shows a top view of a first collection container 1100A, second collection container 1100B, and carrier 1300.

Urine collection system 1000 may include a first collection container 1100A, a second collection container 1100B, a collector 1200, and a carrier 1300. Urine collection system 1000 may include more than two collection containers.

First collection container 1100A and second collection container 1100B may each include a receptacle 1110, a lid 1120, a port 1130, a valve 1140, a fitting 1150, and an aspiration tube 1160. First collection container 1100A and second collection container 1100B may be separate containers. Alternatively, first collection container 1100A and second collection container 1100B may be formed as a unitary whole, such as a single container with an internal partition. First collection container 1100A and second collection container 1100B may be color-coded and/or include markings 1118 such as “AM” and “PM” and/or other suitable markings. Markings 1118 may be located on receptacle 1110, lid 1120, or other suitable location.

Receptacle 1110 receives a urine or other liquid sample. Receptacle 1110 includes a mouth 1112, sides 1114, and a bottom 1116. Mouth 1112 may include threads 1113 for coupling to lid 1120. Receptacle 1110 may be made of plastic-coated paper, plastic, metal, or any other suitable material. Receptacle 1110 may be made of a material that is at least partially translucent. Alternatively, receptacle 1110 may be opaque with a portion that is at least partially translucent with markings to indicate the fill level. Receptacle 1110 may be circular, oval, rectangular, or any other suitable shape. Receptacle 1110 may be proportioned to be short and wide, or has a low center of gravity, to reduce the chance of tipping over.

Lid 1120 seals mouth 1112 of receptacle 1110, and prevents the liquid sample from escaping between lid 1120 and receptacle 1110. Lid 1120 is removably coupled to receptacle 1110. Lid 1120 may include a lip 1122. Lip 1122 may include threads 1123 which are configured to couple to threads 1123 of mouth 1112. Alternatively, lid 1120 may be coupled to receptacle 1110 with a press fit, a twist lock, or any other suitable method or device. Lip 1122 may be knurled or textured to enhance grip.

Lid 1120 may include a vent 1124 configured to allow air to pass in and out of receptacle 1110. Vent 1124 may include an opening formed in lid 1120. Alternatively, vent 1124 may be formed in any other part of receptacle 1110. Vent 1124 may be pinhole-sized or any suitable size. For example, vent 1124 may be less than 1 mm in size. Vent 1124 may be covered by a vent seal 1125 which prevents fluids from entering or escaping receptacle 1110 when vent 1124 is not in use. Vent seal 1125 may be made of paper, plastic, foil, or other suitable material. Vent seal 1125 may be affixed with an adhesive or other suitable method. Vent seal 1125 may have a pull tab, and is easily removed when vent 1124 is ready to be used.

Port 1130 allows receptacle 1110 to be filled, and allows access to the contents of receptacle 1110 when lid 1120 is coupled to receptacle 1110. Port 1130 includes an opening 1132 formed in lid 1120. Port 1130 may also include a recess 1134 formed in lid 1120, with opening 1132 located at a bottom of recess 1134.

Port 1130 may be covered by a port seal 1131 which keeps port 1130 clean until it is ready to be used. Port seal 1131 may be made of paper, plastic, foil, or other suitable material. Port seal 1131 may be affixed with an adhesive or other suitable method. Port seal 1131 may have a pull tab, and is easily removed when port 1130 is ready to be used.

Valve 1140 is coupled to opening 1132 of port 1130. Valve 1140 may be seated at a bottom of recess 1134. Valve 1140 has a top end 1142, a bottom end 1144, and a lumen 1145. Top end 1142 of valve 1140 may be flush with a top of lid 1120. Alternatively, top end 1142 may be recessed with respect to the top of lid 1120 to reduce the possibility of accidental damage, or protrude above the top of lid 1120 to facilitate access.

Fitting 1150 may be coupled to top end 1142 of valve 1140. Fitting 1150 may be a luer attachment or other suitable fitting. Fitting 1150 may be configured to be coupled to a sample collection device, such as any of the embodiments of a handle as described in U.S. Patent Application Publication No. 2007/0025886, or to collector 1200.

Valve 1140 automatically closes to prevent the contents of receptacle 1110 from leaking or escaping through port 1130 when lid 1120 is in place. Valve 1140 opens when mating devices are coupled to fitting 1150. Valve 1140 may be a uni-directional or bi-directional luer-activated checkvalve such as those available from Qosina Corporation, Edgewood, N.Y. or Baxter Healthcare Corporation, Round Lake, Ill.

Aspiration tube 1160 is coupled to opening 1132 of port 1130. Aspiration tube 1160 includes a lumen 1165 that is in fluid communication with lumen 1145 of valve 1140. When lid 1120 is coupled to receptacle 1110, aspiration tube 1160 is of sufficient length to reach at least near bottom 1116 of receptacle 1110. Aspiration tube 1160 allows most of all of the contents of receptacle 1110 to be drawn out through aspiration tube 1160.

Collector 1200 may include a funnel 1210, a main tube 1220, a manifold 1230, a first tube 1240A, and a second tube 1240B.

Funnel 1210 is configured to receive urine or other fluid sample from a patient. Funnel 1210 includes a mouth 1212 and a stem 1214. Funnel 1210 may also have a grip 1216 to facilitate handling and positioning. Funnel 1210 may be configured to conform to the female anatomy to facilitate use by female patients. Alternatively, collector 1200 may not include a funnel 1210 and main tube 1220 may include a Foley catheter.

Main tube 1220 includes a proximal end 1222 coupled to stem 1214 of funnel 1210. Main tube 1220 also includes a distal end 1224.

Manifold 1230 includes an inlet 1232 coupled to distal end 1224 of main tube 1220. Manifold 1230 also includes a first outlet 1234A and a second outlet 1234B.

First tube 1240A includes a proximal end 1242A coupled to first outlet 1234A of manifold 1230. First tube 1240A includes a distal end 1244A coupled to a connector 1250A. Second tube 1240B includes a proximal end 1242B coupled to second outlet 1234B of manifold 1230. Second tube 1240B includes a distal end 1244B coupled to a connector 1250B. Connectors 1250A and 1250B are capable of being coupled to fittings 1150 on first collection container 1100A and second collection container 1100B. In one embodiment, connectors 1250A and 1250B may be luer connectors. Connectors 1250A and 1250B may be configured to rotate freely to facilitate their use.

Flow through main tube 1220 may be controlled by a main tube flow control device 1226. Flow through first tube 1240A and second tube 1240B may be controlled by a first tube flow control device 1246A and a second tube flow control device 1246B, respectively.

Main tube 1220, first tube 1240A, and second tube 1240B may be made of a flexible material, such as surgical rubber. Main tube flow control device 1226 may include a clamp coupled to main tube 1220. First tube flow control device 1246A and second tube flow control device 1246B may include clamps coupled to first tube 1240A and second tube 1240B, respectively. The clamps may be opened and closed to open and close the tubes. Alternatively, main tube flow control device 1226, first tube flow control device 1246A, and second tube flow control device 1246B may include one or more valves or any other suitable devices.

Carrier 1300 may be used to hold first collection container 1100A and second collection container 1100B. Alternatively, carrier 1300 may hold more than two collection containers. Carrier 1300 may include compartments 1301 for each collection container formed by a divider 1302. Carrier 1300 may hold first collection container 1100A and second collection container 1100B loosely or snugly. Carrier 1300 may include a hold 1303. Hold 1303 may be formed in divider 1302 or other suitable location. Carrier 1300 may include one or more latches 1304 configured to couple to indentations 1115 in sides 1114 of receptacles 1110 to secure first collection container 1100A and second collection container 1100B. Carrier 1300 may be color-coded and/or include markings 1308 such as “AM” and “PM” and/or other suitable markings Markings 1308 may be located on compartments 1301, divider 1302, or other suitable location. Carrier 1300 may be foldable or collapsible to facilitate transport and storage. Carrier 1300 may be made of a biodegradable material such as paper or cardboard. Alternatively, carrier 1300 may be made of plastic, metal, or other suitable material.

Urine collection system 1000 is suitable for use as a diurnal urine collection system. Collection container 1100A may be used to collect day urine, or urine from a first length of time, while second container 1100B may be used to collect night urine, or urine from a second length of time. Urine collection system 1000 may also be suitable for use as a portable urinal.

One embodiment of a method of using urine collection system 1000 is as follows. Main tube flow control device 1226 is first opened. First collection container 1100A is used to collect urine by opening first tube flow control device 1246A and closing second tube flow control device 1246B. Second collection container 1100B is used to collect urine by closing first tube flow control device 1246A and opening second tube flow control device 1246B.

After urine collection is complete, first tube 1240A and second tube 1240B may be uncoupled from first collection container 1100A and second collection container 1100B. A sample collection device, such as any of the embodiments of a handle as described in U.S. Patent Application Publication No. 2007/0025886, may then be coupled to first collection container 1100A or second collection container 1100B to obtain a sample of the fluid inside.

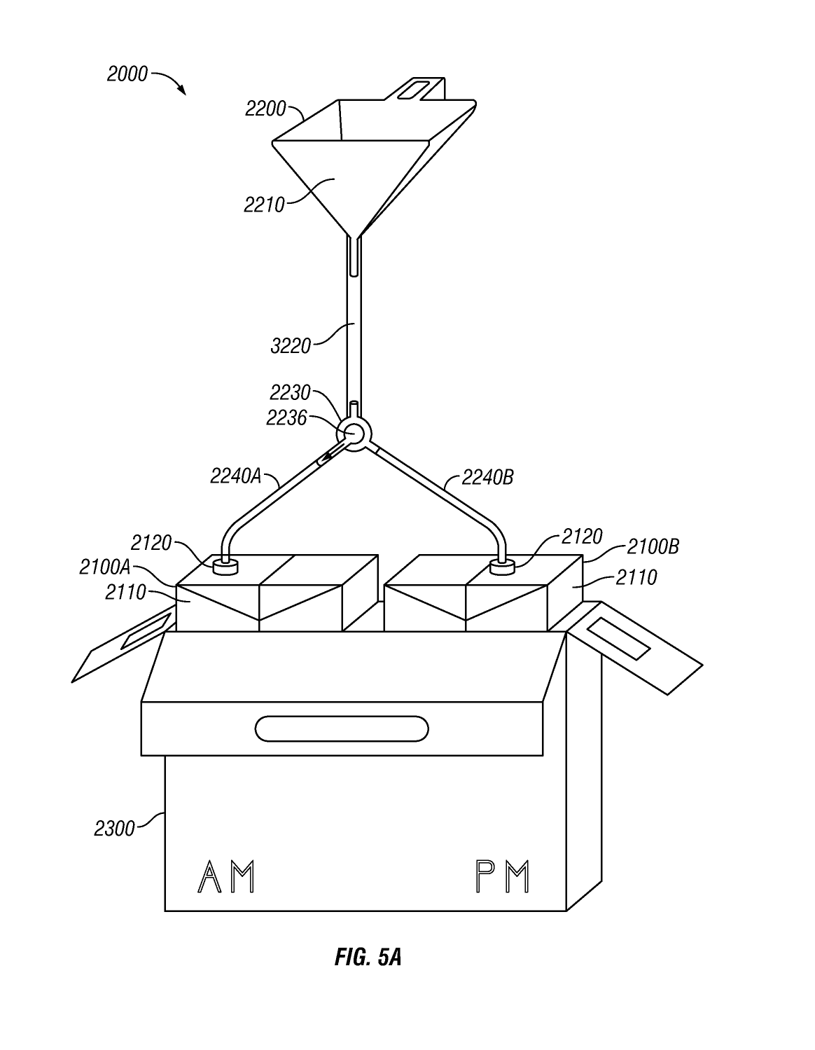

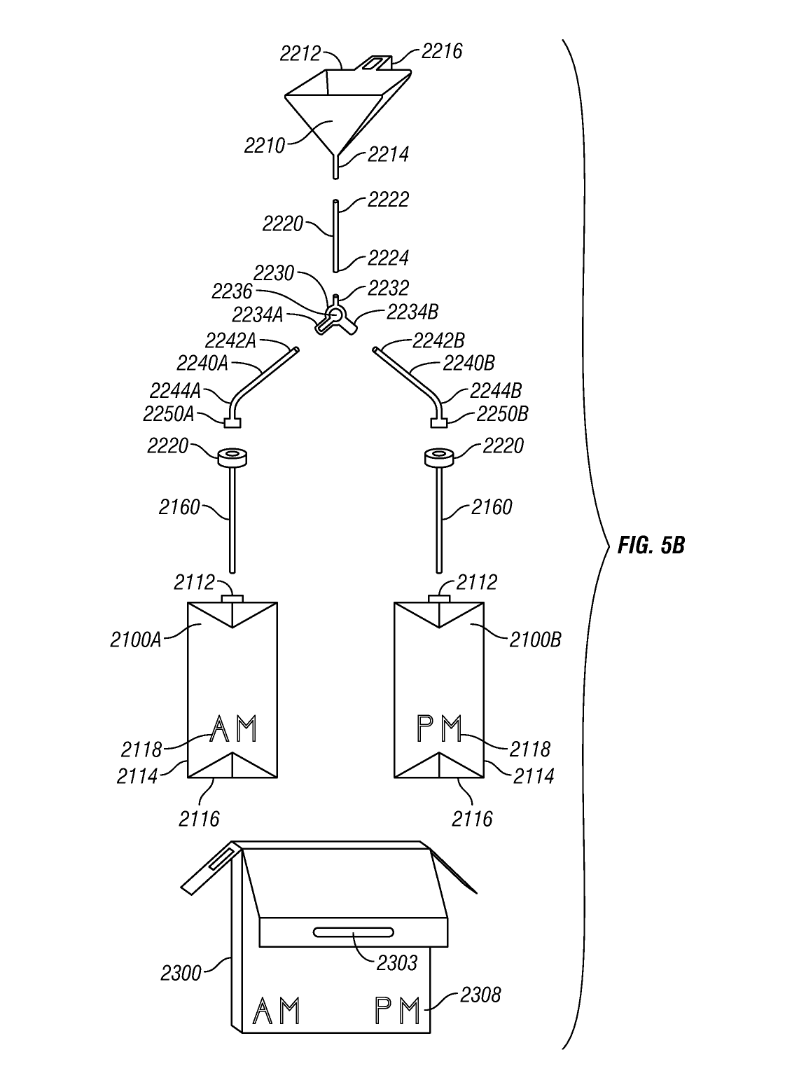

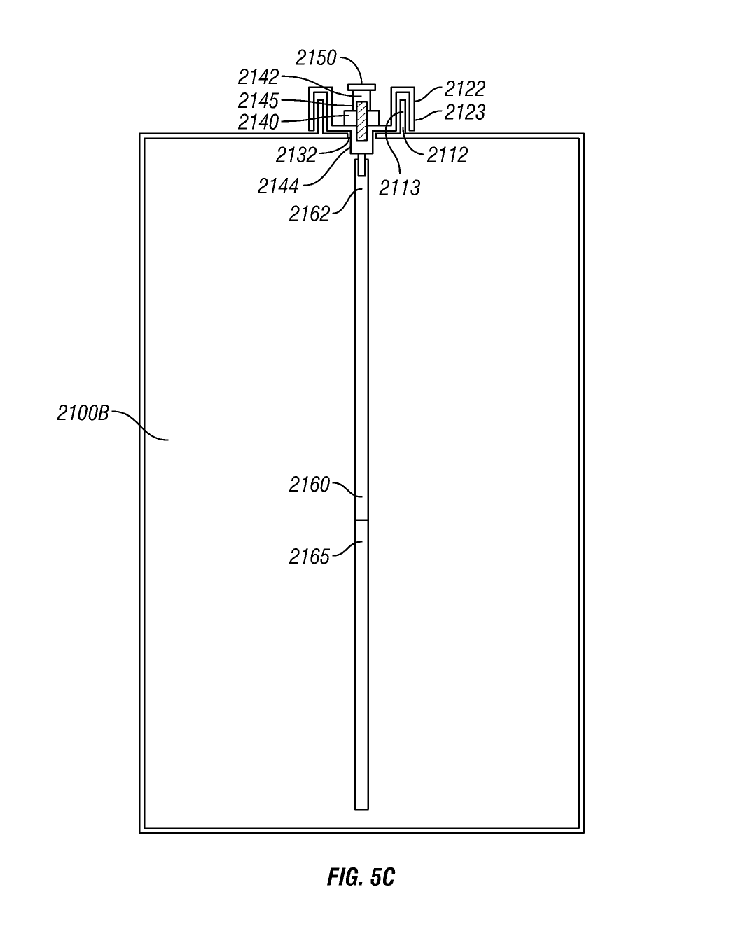

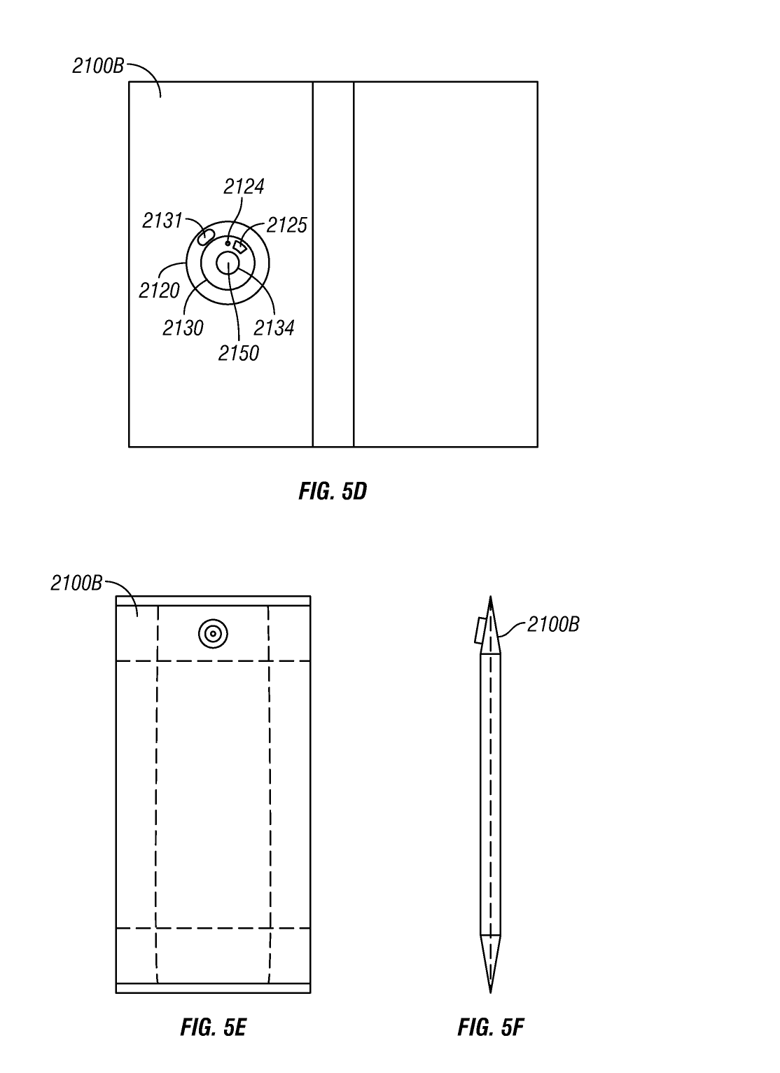

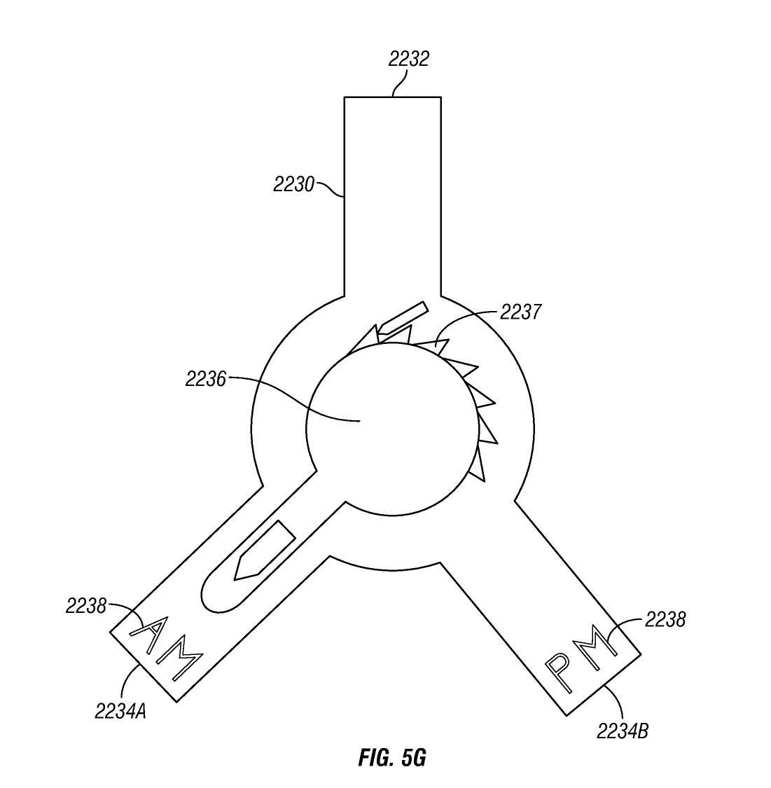

FIGS. 5A-5G show another embodiment of a urine collection system 2000. FIG. 5A shows a perspective view of urine collection system 2000. FIG. 5B shows an exploded view of urine collection system 2000. FIG. 5C shows a side cross-sectional view of a second collection container 2100B. FIG. 5D shows a top view of second collection container 2100B. FIGS. 5E-5F show front and side views of second collection container 2100B in a collapsed form. FIG. 5G shows an enlarged view of a diverter valve 2230.

Urine collection system 2000 may include a first collection container 2100A, a second collection container 2100B, a collector 2200, and a carrier 2300. Urine collection system 2000 may include more than two collection containers.

First collection container 2100A and second collection container 2100B may each include a receptacle 2110, a lid 2120, a port 2130, a valve 2140, a fitting 2150, and an aspiration tube 1160. First collection container 2100A and second collection container 2100B may be separate containers. Alternatively, first collection container 2100A and second collection container 2100B may be formed as a unitary whole, such as a single container with an internal partition. First collection container 2100A and second collection container 2100B may be color-coded and/or include markings 2118 such as “AM” and “PM” and/or other suitable markings. Markings 2118 may be located on receptacle 2110, lid 2120, or other suitable location.

Receptacle 2110 receives a urine or other liquid sample. Receptacle 2110 includes a mouth 2112, sides 2114, and a bottom 2116. Mouth 2112 may include threads 2113 for coupling to lid 2120. Receptacle 2110 may be made of plastic-coated paper, plastic, metal, or any other suitable material. Receptacle 2110 may be made of a material that is at least partially translucent. Alternatively, receptacle 2110 may be opaque with a portion that is at least partially translucent with markings to indicate the fill level. Receptacle 2110 may be circular, oval, rectangular, or any other suitable shape. Receptacle 2110 may be proportioned to be short and wide, or has a low center of gravity, to reduce the chance of tipping over.

Receptacle 2110 may be foldable or collapsible to facilitate transport and storage. For example, receptacle 2110 may include a foldable or collapsible plastic-coated paper carton such as those manufactured by Tetra Pak, Pully, Switzerland.

Lid 2120 seals mouth 2112 of receptacle 2110, and prevents the liquid sample from escaping between lid 2120 and receptacle 2110. Lid 2120 is removably coupled to receptacle 2110. Lid 2120 may include a lip 2122. Lip 2122 may include threads 2123 which are configured to couple to threads 2123 of mouth 2112. Alternatively, lid 2120 may be coupled to receptacle 2110 with a press fit, a twist lock, or any other suitable method or device. Lip 2122 may be knurled or textured to enhance grip.

Lid 2120 may include a vent 2124 configured to allow air to pass in and out of receptacle 2110. Vent 2124 may include an opening formed in lid 2120. Alternatively, vent 2124 may be formed in any other part of receptacle 2110. Vent 2124 may be pinhole-sized or any suitable size. For example, vent 2124 may be less than 1 mm in size. Vent 2124 may be covered by a vent seal 2125 which prevents fluids from entering or escaping receptacle 2110 when vent 2124 is not in use. Vent seal 2125 may be made of paper, plastic, foil, or other suitable material. Vent seal 2125 may be affixed with an adhesive or other suitable method. Vent seal 2125 may have a pull tab, and is easily removed when vent 2124 is ready to be used.

Port 2130 allows receptacle 2110 to be filled, and allows access to the contents of receptacle 2110 when lid 2120 is coupled to receptacle 2110. Port 2130 includes an opening 2132 formed in lid 2120. Port 2130 may also include a recess 2134 formed in lid 2120, with opening 2132 located at a bottom of recess 2134.

Port 2130 may be covered by a port seal 2131 which keeps port 2130 clean until it is ready to be used. Port seal 2131 may be made of paper, plastic, foil, or other suitable material. Port seal 2131 may be affixed with an adhesive or other suitable method. Port seal 2131 may have a pull tab, and is easily removed when port 2130 is ready to be used.

Valve 2140 is coupled to opening 2132 of port 2130. Valve 2140 may be seated at a bottom of recess 2134. Valve 2140 has a top end 2142, a bottom end 2144, and a lumen 2145. Top end 2142 of valve 2140 may be flush with a top of lid 2120. Alternatively, top end 2142 may be recessed with respect to the top of lid 2120 to reduce the possibility of accidental damage, or protrude above the top of lid 2120 to facilitate access.

Fitting 2150 may be coupled to top end 2142 of valve 2140. Fitting 2150 may be a luer attachment or other suitable fitting. Fitting 2150 may be configured to be coupled to a sample collection device, such as any of the embodiments of a handle as described in U.S. Patent Application Publication No. 2007/0025886, or to funnel assembly 2100.

Valve 2140 automatically closes to prevent the contents of receptacle 2110 from leaking or escaping through port 2130 when lid 2120 is in place. Valve 2140 opens when mating devices are coupled to fitting 2150. Valve 2140 may be a uni-directional or bi-directional luer-activated checkvalve such as those available from Qosina Corporation, Edgewood, N.Y. or Baxter Healthcare Corporation, Round Lake, Ill.

Aspiration tube 2160 is coupled to opening 2132 of port 2130. Aspiration tube 2160 includes a lumen 2165 that is in fluid communication with lumen 2145 of valve 2140. When lid 2120 is coupled to receptacle 2110, aspiration tube 2160 is of sufficient length to reach at least near bottom 2116 of receptacle 2110. Aspiration tube 2160 allows most of all of the contents of receptacle 2110 to be drawn out through aspiration tube 2160.

Aspiration tube 2160 may be configured to flex or bend to prevent kinking when used with the changing dimensions of a foldable or collapsible receptacle 2110. At least a portion of aspiration tube 2160 may be made of a flexible material. For example, approximately 1 inch of a proximal portion 2162 of aspiration tube 2160 may be made of a flexible material, with the remainder of aspiration tube 2160 made of a stiff material. As another example, an entire length of aspiration tube 2160 may be made of a flexible material. Aspiration tube 2160 may be made of an elastomer or other material which is soft when compressed but rigid when uncompressed.

Collector 2200 may include a funnel 2210, a main tube 2220, a diverter valve 2230, a first tube 2240A, and a second tube 2240B.

Funnel 2210 is configured to receive urine or other fluid sample from a patient. Funnel 2210 includes a mouth 2212 and a stem 2214. Funnel 2210 may also have a grip 2216 to facilitate handling and positioning. Funnel 2210 may be configured to conform to the female anatomy to facilitate use by female patients. Alternatively, collector 2200 may not include a funnel 2210 and main tube 2220 may include a Foley catheter.

Main tube 2220 includes a proximal end 2222 coupled to stem 2214 of funnel 2210. Main tube 2220 also includes a distal end 2224.

Diverter valve 2230 includes an inlet 2232 coupled to distal end 2224 of main tube 2220. Diverter valve 2230 also includes a first outlet 2234A and a second outlet 2234B.

First tube 2240A includes a proximal end 2242A coupled to first outlet 2234A of diverter valve 2230. First tube 2240A includes a distal end 2244A coupled to a connector 2250A. Second tube 2240B includes a proximal end 2242B coupled to second outlet 2234B of diverter valve 2230. Second tube 2240B includes a distal end 2244B coupled to a connector 2250B. Connectors 2250A and 2250B are capable of being coupled to fittings 2150 on first collection container 2100A and second collection container 2100B. In one embodiment, connectors 2250A and 2250B may be luer connectors. Connectors 2250A and 2250B may be configured to rotate freely to facilitate their use.

Diverter valve 2230 may be configurable to direct flow from inlet 2232 to either first outlet 2234A or second outlet 2234B. Diverter valve 2230 may have a first position configured to direct flow from funnel 2210 and main tube 2220 into first tube 2240A and first collection container 2100A. Diverter valve 2230 may have a second position configured to direct flow from funnel 2210 and main tube 2220 into second tube 2240B and second collection container 2100B. Diverter valve 2230 may include a knob or lever 2236 which allows diverter valve 2230 to be switched between the first position and the second position. Lever 2236 may include an arrow or other suitable marking. Lever 2236 may include one or more detents configured to provide audio and/or tactile feedback that lever 2236 is in the first position and/or the second position. Diverter valve 2230 may include a lock 2237 which allows diverter valve 2230 to be switched from first outlet 2234A to second outlet 2234B or vice versa only once. Lock 2237 may include a ratchet, a clip, or any other suitable device. Diverter valve 2230 may be color-coded and/or include markings 2238 such as “AM” and “PM” and/or other suitable markings.

Carrier 2300 may be used to hold first collection container 2100A and second collection container 2100B. Alternatively, carrier 2300 may hold more than two collection containers. Carrier 2300 may hold first collection container 2100A and second collection container 2100B loosely or snugly. Carrier 2300 may include a hold 2303. Carrier 2300 may be color-coded and/or include markings 2308 such as “AM” and “PM” and/or other suitable markings. Markings 2308 may be located inside carrier 2300 or any other suitable location. Carrier 2300 may be foldable or collapsible to facilitate transport and storage. Carrier 2300 may be made of a biodegradable material such as paper or cardboard. Alternatively, carrier 2300 may be made of plastic, metal, or other suitable material. Carrier 2300 may be decorated with graphics, such as flowers, pictures, or scenery. Carrier 2300 may be decorated to conceal its contents and purpose.

Urine collection system 2000 is suitable for use as a diurnal urine collection system. Collection container 2100A may be used to collect day urine, or urine from a first length of time, while second container 2100B may be used to collect night urine, or urine from a second length of time. Urine collection system 2000 may also be suitable for use as a portable urinal.

One embodiment of a method of using urine collection system 2000 is as follows. Diverter valve 2236 may be initially in a first position configured to direct flow from funnel 2210 and main tube 2220 into first tube 2240A and first collection container 2100A. First collection container 2100A may be used to collect urine. Diverter valve 2236 may then be switched to a second position configured to direct flow from funnel 2210 and main tube 2220 into second tube 2240B and second collection container 2100B. Second collection container 2100B may then be used to collect urine.

After urine collection is complete, first tube 2240A and second tube 2240B may be uncoupled from first collection container 2100A and second collection container 2100B. A sample collection device, such as any of the embodiments of a handle as described in U.S. Patent Application Publication No. 2007/0025886, may then be coupled to first collection container 2100A or second collection container 2100B to obtain a sample of the fluid inside

While the foregoing has been with reference to particular embodiments of the invention, it will be appreciated by those skilled in the art that changes in these embodiments may be made without departing from the principles and spirit of the invention.

All publications and patent applications mentioned in this specification are herein incorporated by reference to the same extent as if each individual publication or patent application was specifically and individually indicated to be incorporated by reference.

1. A collection system for a liquid sample, the system comprising:
a first collection container;
a second collection container;
a funnel; and
a diverter valve coupled to the first collection container, the second collection container, and the funnel, the diverter valve having a first position configured to direct the liquid sample from the funnel into the first collection container, the diverter valve having a second position configured to direct the liquid sample from the funnel into the second collection container.

2. The collection system of claim 1, wherein the first and second collection containers include markings to indicate different time periods for collection of the liquid sample.

3. The collection system of claim 1, wherein the diverter valve includes markings to indicate different time periods for collection of the liquid sample.

4. The collection system of claim 1, wherein the diverter valve includes a lock which allows the diverter valve to be switched from the first position to the second position or vice versa only once.

5. The collection system of claim 4, wherein the lock includes a ratchet.

6. The collection system of claim 4, wherein the lock includes a clip.

7. The collection system of claim 1, further comprising:
a carrier configured to hold the first collection container and the second collection container.

8. The collection system of claim 1, wherein the carrier includes markings to indicate different time periods for collection of the liquid sample.

9. A collection system for a liquid sample, the system comprising:
a first collection container including a first port;
a second collection container including a second port;
a funnel having a mouth and a stem;
a main tube having a proximal end coupled to the stem of the funnel;
a diverter valve having an inlet, a first outlet, and a second outlet, the inlet being coupled to a distal end of the main tube, the diverter valve having a first position configured to direct the liquid sample from the inlet to the first outlet, the diverter valve having a second position configured to direct the liquid sample from the inlet to the second outlet;
a first tube having a proximal end coupled to the first outlet of the diverter valve;
a first connector coupled to a distal end of the first tube, the first connector configured to be coupled to the first port of the first collection container;
a second tube having a proximal end coupled to the second outlet of the diverter valve; and
a second connector coupled to a distal end of the second tube, the second connector configured to be coupled to the second port of the second collection container.

10. The collection system of claim 9, wherein the first port has a first valve having a normally closed configuration which prevents the liquid sample inside the first collection container from escaping through the first valve, the first valve having an open configuration when the first connector is coupled to the first valve; and
wherein the second port has a second valve having a normally closed configuration which prevents the liquid sample inside the second collection container from escaping through the second valve, the second valve having an open configuration when the second connector is coupled to the second valve.

11. The collection system of claim 10, wherein the first and second valves include luer-activated checkvalves, and wherein the first and second connectors include luer connectors.

12. The collection system of claim 9, wherein the first and second collection containers include markings to indicate different time periods for collection of the liquid sample.

13. The collection system of claim 9, wherein the diverter valve includes markings to indicate different time periods for collection of the liquid sample.

14. The collection system of claim 9, wherein the diverter valve includes a lock which allows the diverter valve to be switched from the first position to the second position or vice versa only once.

15. The collection system of claim 14, wherein the lock includes a ratchet.

16. The collection system of claim 14, wherein the lock includes a clip.

17. The collection system of claim 9, further comprising:
a carrier configured to hold the first collection container and the second collection container.

18. The collection system of claim 9, wherein the carrier includes markings to indicate different time periods for collection of the liquid sample.

19. A collection system for a liquid sample, the system comprising:
a first collection container;
a second collection container;
a funnel; and
means for selectively directing the liquid sample from the funnel into the first collection container or the second collection container.

20. (canceled)
